(19) United States
(12) Patent Application Publication
(10) Pub. No.: US 2025/0184020 A1
(43) Pub. Date: Jun. 5, 2025

(54) A METHOD AND APPARATUS FOR SELECTING A TRANSPORT FORMAT FOR A RADIO TRANSMISSION

(71) Applicant: Telefonaktiebolaget LM Ericsson (PUBL), Stockholm (SE)

(72) Inventors: Majid GERAMI, Lund (SE); Sara SANDBERG, Luleå (SE); Luis Felipe DEL CARPIO VEGA, Espoo (FI); Jonas FRÖBERG OLSSON, Ljungsbro (SE)

(21) Appl. No.: 18/846,051

(22) PCT Filed: Mar. 11, 2022
(86) PCT No.: PCT/EP2022/056396

§ 371 Date: Sep. 11, 2024

(51) Int. Cl. H04B 17/336; H04L 1/00

(52) U.S. Cl. CPC H04B 17/336; H04L 1/0006

(57) ABSTRACT

There is provided a method, performed by a network node, for selecting a transport format for a radio transmission. The method comprises obtaining an estimate of expected Signal Interference to Noise Ratio, SINR, for a radio transmission. The method further comprises determining a margin in dependence on a value of the estimate of SINR. The method further comprises selecting a transport format for the radio transmission based on the estimate of SINR for the radio transmission and the determined margin. There is further provided a network node. There is also provided a method, performed by a user equipment, for assisting the selection of a transport format for a radio transmission. There is further provided a user equipment.

### TECHNICAL FIELD

The disclosure relates to a method for selecting a transport format for a radio transmission. The disclosure further relates to a method for assisting selection of a transport format for a radio transmission. The disclosure further relates to a network node and to a user equipment.

### BACKGROUND

An NR NodeB (gNB) comprises a scheduler which is responsible for resource allocation to User Equipment's, UEs, in connected mode, both in uplink (transmissions from a UE to the gNB) and downlink (transmissions from the gNB to the UE). The scheduler receives, from the core, input on the required Quality of Service, QoS, for each UE/service. The scheduler also communicates with a Link Adaption, LA, process which selects an appropriate transport format for each uplink/downlink transmission. The LA process may select a transport format for a transmission based on numerous factors, including an estimate of expected Signal to Interference Noise Ratio, SINR, for the transmission.

For a high estimate of SINR, a high Modulating and Coding Scheme, MCS, may be selected for the transmission. For a low estimate of SINR, a low Modulation and Coding Scheme, MCS, may be selected for the transmission.

The LA process may also consider the outcome of previous transmissions from/to the UE (e.g. whether an ACK or NACK is received from the UE in respect of the previous transmission), the UE's power headroom, and the available bandwidth, when selecting a transport format for a transmission.

FIG. 1 is a schematic diagram of a communications network 10 illustrating the Link Adaption process. The communications network 10 comprises a Quality of Service, QoS, unit 12, which may be located in the core (not shown). The QoS unit 12 sends information to a scheduler 14, which may be located in a network node such as a gNB (not shown). The scheduler 14 further communicates with a link adaption unit 16, which may also be located in the gNB. As indicated by an arrow in FIG. 1, resource assignments for uplink, UL, and downlink, DL, transmissions are sent, from the network 10, to a UE 18. A power control unit 19 in the gNB may also send a transmit power control command, TPC, to the UE 18 in respect of an uplink transmission. On the other hand, as indicated by a further arrow, the UE 18 may transmit downlink channel feedback to the network 10.

FIG. 2 shows, by way of example, the functionality of the link adaption unit 16, and the UE 18, in more detail, in relation to selecting a transport format for a downlink transmission (to be transmitted from the gNB 11 to the UE 18). FIG. 3 shows, by way of example, the functionality of the link adaption unit 16, and the UE 18, in more detail, in relation to selecting a transport format for an uplink transmission (to be transmitted from the UE 18 to the gNB 11). As indicated by arrows in FIGS. 2 and 3, the gNB 11 may send a grant to the UE 18 for the DL/UL transmission according to the selected transport format and Resource Blocks, RBs.

The link adaption unit 16, in each of FIGS. 2 and 3, selects the transport format for a transmission based on an estimate of SINR for the transmission.

In FIG. 2, in respect of the downlink, the link adaption unit 16 uses CSI report(s) received from the UE 18 to produce an estimate of SINR for an upcoming transmission. In this example, the CSI report(s) contain Channel Quality Information, CQI, Rank Indication, RI and Precoding Matrix Indicator, PMI. The CSI report(s) are based on the results of measurements of Channel State Information Reference Signals, CSI-RS, made by the UE 106, the CSI-RS being transmitted from the gNB 11 to the UE 18 over a downlink channel.

However, depending on when the CSI measurements were made by the UE 18, a CSI report may be outdated at the time of its transmission to the gNB 11. This is because, whilst the reference signal measurements may be made at time slot ‘n’, the CSI report containing results based on the measurements may not be transmitted until time slot ‘n+N’ where N>0. In any case, due to channel variation and changes in interference, it is difficult to accurately estimate, or in other words predict, SINR for an upcoming transmission. This accuracy can also be impacted by one or more of CSI report quantization, CQI to SINR mapping error, fading channel variation, intercell/intracell interference variation and CSI-RS/DMRS measurement error.

In FIG. 3, in respect of the uplink, it is indicated that the link adaptation unit 16 may obtain an estimate of SINR from measurements of reference signals made by the gNB 11, these reference signals being transmitted from the UE 18 to the gNB 11 over the uplink. For example, as indicated in FIG. 3, these reference signals may be Sounding Reference Signals (SRS) or Demodulation Reference Signals (DMRS).

However, again, depending on the periodicity of the measurements, these measurements, made by the gNB 11, may also be outdated at the time of estimating SINR. Furthermore, similarly to the case for the downlink, the estimate or prediction of SINR for an upcoming uplink transmission may be incorrect due to channel variation and changes in interference. Thus, sources of error for UL SINR estimation can include outdated reference signal measurement, fading channel variation, intercell/intracell interference variation and SRS/DRS measurement error.

Thus, it will be understood that the estimate of SINR for a transmission may differ from the actual or realised SINR which is experienced by the transmission.

To compensate for error in the SINR estimate, the LA process, as indicated in both FIGS. 2 and 3, may include an inner loop link adaptation (ILLA) unit 15 and an outer loop link adaptation (OLLA) unit 17.

In the ILLA unit 15, a compensation is applied to the estimate of SINR by adding a Link Adaptation Margin, LAM, to the estimate. All UEs in a cell which have strict reliability requirements use the same margin. UEs with less strict reliability requirements or less strict latency requirements may use a smaller margin or no margin at all. The LA 16 then selects a transport format, which may comprise a Modulation and Coding Scheme, MCS, for the transmission based on the estimate of SINR and the LAM.

If the margin is positive, the LA 16 selects a more conservative (lower) MCS for the transmission than it would do based solely on the estimate of SINR. For example, the graph in FIG. 4 illustrates that, according to one example, if the LAM=4 dB, where the estimated SINR=5 dB, for target BLER (Block Error Rate) of 10⁻⁵, MCS=9 may be selected, compared to MCS=13 if the LAM were zero.

The OLLA unit 17 uses HARQ (Hybrid Automatic Repeat request) ACK/NACK or BLER of previous transmissions on the respective channel to further inform the transport format selection for a transmission. An arrow in FIG. 2 illustrates, in respect of the downlink, that the UE 18 may transmit HARQ to the gNB 11, to notify the gNB 11 of whether a scheduled data transmission has been successfully received. In respect of the uplink, an arrow in FIG. 3 shows that the gNB 11 may receive for example a PUSCH (Physical Uplink Shared Control Channel) transmission from the UE 18 and the decoding outcome, at the gNB 11, may be an ACK or NACK.

In both cases this ACK/NACK information, whether received from the UE 18 or generated by the gNB 11, is received by the OLLA unit 17 which determines a value Δ_{OLLA}. This value is added to the estimate of SINR. If there is an ACK for the last transmission to/from a particular UE 18, meaning that the last transmission was successful, a Δ_{ACK} is added to the LAM. Note Δ_{Ack} is always negative. This means that a less conservative (higher) MCS selection will be made for the next transmission. On the other hand, if a NACK is received for the last transmission from/to a particular user, meaning that the last transmission was unsuccessful, Δ_{NACK} is added to the LAM. Note Δ_{NACK} is always positive. This means that the MCS selection will be more conservative (lower) for the next transmission. For example, Δ_{NACK} may equal −9*Δ_{ACK} for a BLER target of 10%.

### SUMMARY

The applicant has appreciated that it would be desirable to provide a more efficient link adaption process.

According to a first aspect of the disclosure, there is provided a method, performed by a network node, for selecting a transport format for a radio transmission. The method comprises obtaining an estimate of expected Signal Interference to Noise Ratio, SINR, for the radio transmission. The method further comprises determining a margin in dependence on a value of the estimate of SINR. The method further comprises selecting a transport format for the radio transmission based on the estimate of SINR for the radio transmission and the margin.

The Applicant has identified, through observations of SINR estimation error statistics, that certain values of SINR estimates can have a smaller margin than other values of SINR estimate, without reducing the reliability of transmission. Thus, by determining the margin in dependence on the value of the estimate of SINR for a transmission, advantageously, a different margin may be applied depending on the SINR estimate, and a more efficient transport format may be selected for the transmission. Thus, advantageously, scheduling flexibility may be increased, spectral efficiency may be increased, interference in the network may be reduced and latency of transmissions may potentially be reduced, without decreasing the reliability of a transmission below a desired level.

This solution may be especially beneficial for transmissions which require high reliability and low bounded latency, for example but not exclusively for URLLC (ultra-reliable low-latency communication) services.

The margin may be a Link Adaptation Margin, LAM.

In an embodiment, the margin is determined in dependence on a magnitude of the estimate of SINR for the radio transmission.

The margin may be determined according to a rule such that a smaller margin is selected for a lower estimate of SINR than for a higher estimate of SINR.

Experiments have shown that the likely magnitude of SINR estimate error is less for lower estimates of SINR than for higher estimates of SINR. The Applicant has appreciated that a smaller margin may therefore be selected for use with lower estimates of SINR, compared to that which would be selected for a higher estimate of SINR. This may be due to the likelihood that, when there is high SINR, typically fewer (or none) neighboring cells are transmitting at the same time. In that case, if one neighboring cell starts or stops transmitting that will have a large percentage impact on the SINR. If few (or none) neighboring cells are transmitting, the likelihood that a neighboring cell stops transmitting is much lower than the likelihood that one or more of the neighboring cells starts transmitting. On the other hand, if there is low SINR, it may be more likely that all or many neighboring cells are transmitting at that time. If one cell stops transmitting, that could increase SINR, but the amount by which SINR is changed won't be that large.

In an embodiment, determining the margin in dependence on a value of the estimate of SINR may comprise selecting the margin from a plurality of margin values in dependence on the value of the estimate of SINR.

In this case, at least two of the plurality of margin values may be for use with respective values of estimate SINR.

In some embodiments, selecting the margin may comprise selecting a first of the at least two margin values when the estimate of SINR exceeds a threshold and selecting a second of the at least two margin values when the estimate of SINR is lower than the threshold. In embodiments, the first margin value is larger (higher) than the second margin value.

In some embodiments, at least one of the margin values may be a value intrapolated or extrapolated from at least two other of the plurality of margin values. The Applicant has identified that this method may provide more accurate margin values, in comparison to a fixed margin approach applied regardless of the value of the SINR estimate for the transmission but may advantageously reduce the computational resources required to determine the plurality of margin values.

The margin may be determined based on calculations of SINR estimation error in respect of previous transmissions. For example, at least one of (or at least two of) the plurality of margin values may be determined based on calculations of SINR estimation error in respect of previous radio transmissions.

In embodiments, the margin may be determined in dependence on the value of the estimate of SINR and based on at least one of: a service type of traffic carried by the radio transmission; a service requirement, such as one or more of: a reliability requirement, a latency requirement, a spectral efficiency requirement and a BLER requirement; environment conditions; allocation size of the radio transmission; whether the radio transmission is a re-transmission; and an outcome of a previous transmission over the same communications channel.

The radio transmission may be an uplink radio transmission or a downlink radio transmission. For example, the radio transmission may carry a URLLC (ultra-reliable low-latency communication) service.

In embodiments, obtaining the estimate of SINR for the radio transmission may comprise at least one of: estimating SINR based on reference signal measurements; determining the estimate of SINR from one or more Channel State Information reports received from a user equipment; and receiving the estimate of SINR.

The transport format may be a transport block format. The transport format may be at least one of: a modulation and coding scheme; a precoder and a number of layers for the transmission.

The method may further comprise scheduling the radio transmission according to the selected transport format, wherein scheduling the radio transmission may comprise sending a scheduling assignment to a user equipment.

According to a further aspect of the disclosure there is provided a network node. The network node comprises processing circuitry configured to obtain an estimate of expected Signal Interference to Noise Ratio, SINR, for a radio transmission. The processing circuitry is further configured to determine a margin in dependence on a value of the estimate of SINR; and select a transport block format for the radio transmission based on the estimate of SINR for the radio transmission and the margin. The network node further comprises power supply circuitry configured to supply power to the processing circuitry.

There is further provided a method, performed by a user equipment, for assisting selection of a transport format for a radio transmission. The method comprises obtaining an estimate of expected Signal Interference to Noise Ratio, SINR, for a radio transmission. The method further comprises determining a margin in dependence on a value of the estimate of SINR. The method further comprises transmitting information based on the margin to a network node to assist in the selection of a transport format for the radio transmission.

There is further provided a user equipment comprising processing circuitry configured to obtain an estimate of expected Signal Interference to Noise Ratio, SINR, for a radio transmission. The processing circuitry is further configured to determine a margin in dependence on a value of the estimate of SINR; and transmit information based on the margin to a network node to assist in the selection of a transport format for the radio transmission. The user equipment further comprises power supply circuitry configured to supply power to the processing circuitry.

### BRIEF DESCRIPTION OF THE FIGURES

The following Figures have been described above:

FIG. 1 shows a schematic diagram of a communications network;

FIG. 2 shows example link adaptation functionality in respect of the downlink;

FIG. 3 shows example link adaptation functionality in respect of the uplink;

FIG. 4 is a graph showing an example of Modulation and Coding Scheme selection when a LAM is applied;

Embodiments of the present invention will now be described, by way of example only, and with reference to the accompanying drawings in which:

FIG. 5 shows an example of a communications system according to some embodiments;

FIG. 6 is a graph showing experienced SINR and estimated SINR in one example;

FIG. 7 is a graph showing an example of how the size of a LAM can reduce spectral efficiency;

FIG. 8 is a flow chart showing a method in a network node according to an embodiment of the present invention;

FIG. 9 is a schematic drawing of an LA process according to an embodiment of the present invention;

FIG. 10 is a graph showing the required LAM for respective values of estimated SINR according to examples of the present invention;

FIG. 11 is a flow diagram showing a method of selecting a LAM according to an embodiment of the present invention;

FIG. 12 shows a plurality of LAMs for use with respective ranges of estimated SINR according to an embodiment of the present invention;

FIG. 13 illustrates LAMs for use with respective values of estimated SINR according to examples of the present invention;

FIG. 14 illustrates LAMs for use with respective values of estimated SINR according to a further examples of the present invention;

FIG. 15 illustrates a method of determining a margin according to an embodiment of the present invention;

FIG. 16 illustrates a method of determining a margin according to an embodiment of the present invention;

FIG. 17 illustrates a method of determining a margin according to an embodiment of the present invention;

FIG. 18 is flow diagram showing a method by a user equipment according to an embodiment of the present invention.

FIG. 19 is a diagram of a network node according to an embodiment of the present invention;

FIG. 20 is a diagram of a network node according to an embodiment of the present invention;

FIG. 21 is a diagram of a user equipment according to an embodiment of the present invention;

FIG. 22 is a diagram of a user equipment according to an embodiment of the present invention;

FIG. 23 is a block diagram of a host which may be an embodiment of the host shown in FIG. 5;

FIG. 24 is a block diagram illustrating a virtualisation environment;

FIG. 25 shows a communications diagram of a host communicating via a network node with a UE over a partially wireless connection according to some embodiments.

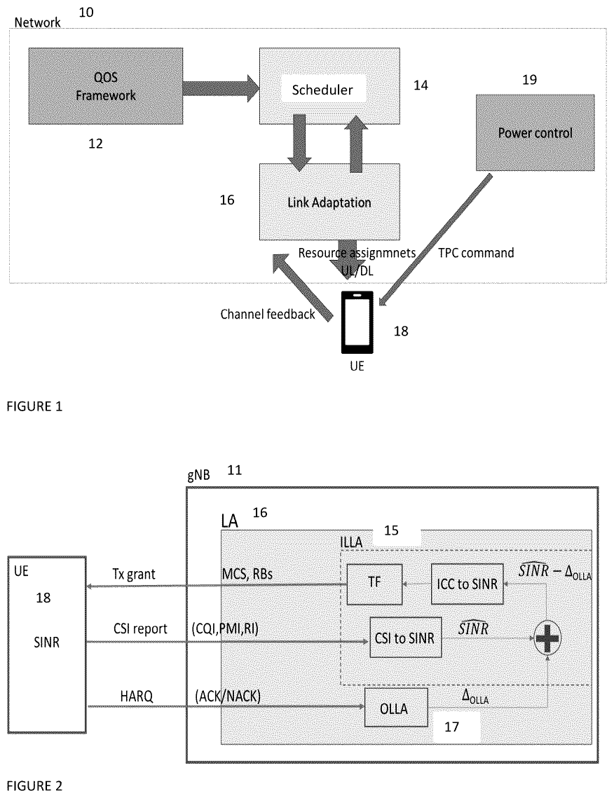

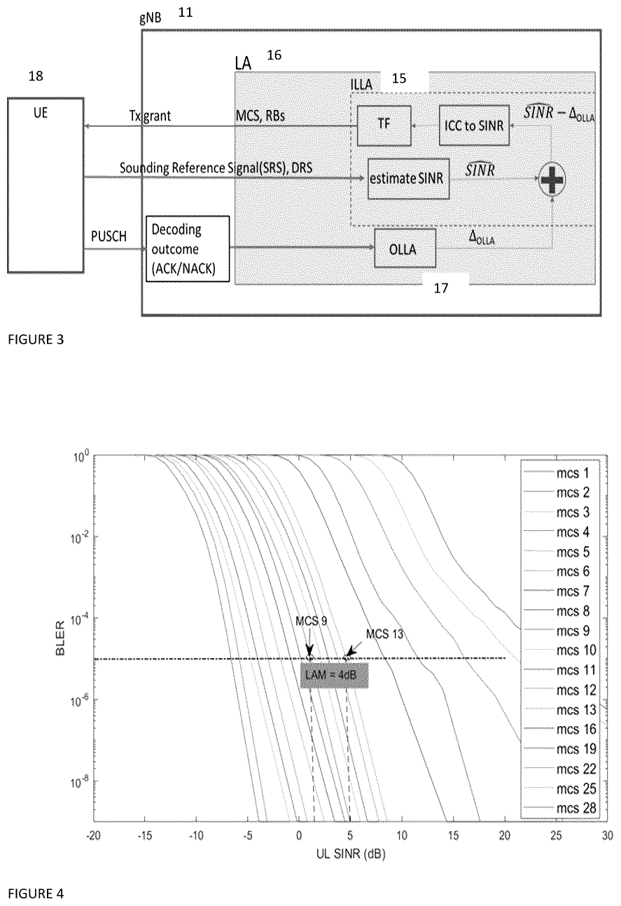

### DETAILED DESCRIPTION

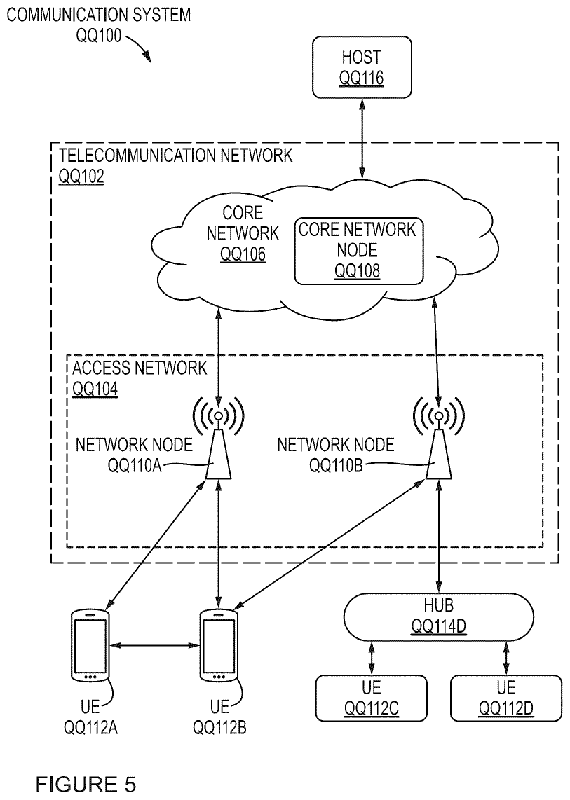

FIG. 5 shows an example of a communication system 100 in accordance with some embodiments.

In the example, the communication system 100 includes a telecommunication network 102 that includes an access network 104, such as a radio access network (RAN), and a core network 406, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 10 facilitate direct or indirect connection of user equipment (UE), such as by connecting UEs 112a, 112b, 112c, and 112d (one or more of which may be generally referred to as UEs 112) to the core network 106 over one or more wireless connections.

In different embodiments, the communication system 100 may include any number of wired or wireless networks, network nodes, UEs, and/or any other components or systems that may facilitate or participate in the communication of data and/or signals whether via wired or wireless connections.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 5 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

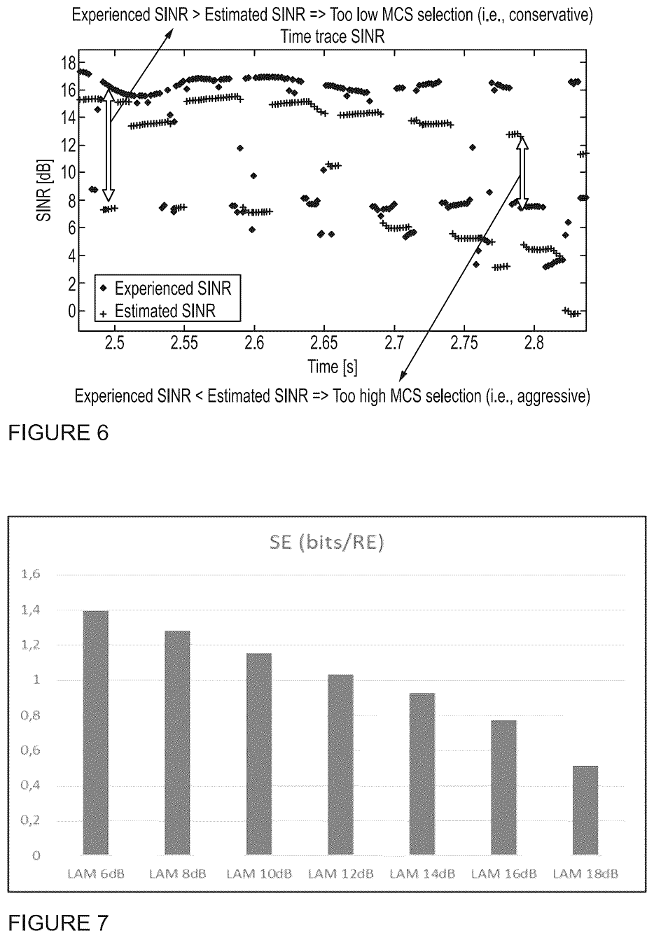

As mentioned above, in relation to link adaption, estimates of SINR for a transmission may differ from the actual or realised SINR which is experienced by the transmission, regardless of whether the transmission is an uplink transmission (from a UE to a network node) or a downlink transmission (from the network node to a UE). FIG. 6 is a graph showing experienced SINR vs estimated SINR over time according to one example. It is seen that at some times the experienced SINR is greater than the estimated SINR, whereas at other times the experienced SINR is lower than the estimated SINR. This may result in for example too conservative (too low) or too aggressive (too high) a selection of Modulation and Coding Scheme for the transmission. Too low a MCS selection may unnecessarily reduce spectral efficiency, increase interference in the network and possibly increase latency of the transmission. However, too high a MCS selection may critically reduce the reliability of the transmission.

As described above, to compensate for this error a margin can be applied to the estimate of SINR. This will increase the reliability of the transmission. However, the applicant has appreciated that this increase in reliability is at the cost of reducing spectral efficiency, increasing interference in the network and possibly increasing the latency of the transmission. FIG. 7 is a graph showing the extent to which spectral efficiency may be reduced as the size of the LAM increases, in one example.

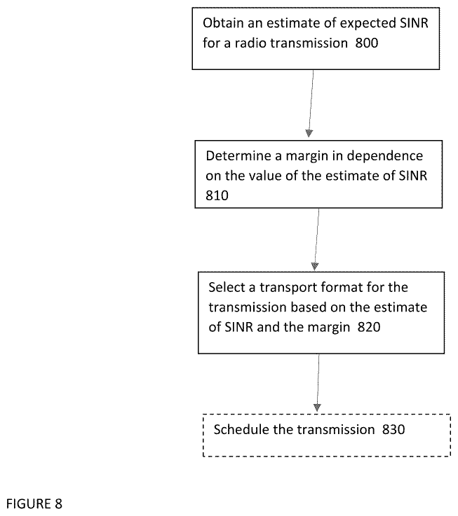

FIG. 8 is a flow chart showing a method according to an embodiment of the present invention. The method may be performed by a network node.

The method comprises, at 800, obtaining an estimate of expected Signal Interference to Noise Ratio, SINR, for a radio transmission. The radio transmission may be an uplink radio transmission (to be transmitted from a UE to the network node) or a downlink radio transmission (to be transmitted from the network node to a UE).

The radio transmission may be any type of radio transmission. However, the method may be particularly beneficially for transmissions which require high reliability within a low bounded latency, for example for URLLC (ultra-reliable low-latency communication) services. If the reliability requirement is not very high, there may be no need for a margin to increase reliability. On the other hand, if there is no strict bounded latency requirement it may be possible to rely on HARQ retransmissions to achieve high reliability. However, in the special case, where high reliability and a low bounded latency is required, it is advantageous to select the margin wisely.

The method further comprises, at 810, determining a margin in dependence on a value of the estimate of SINR for the transmission. The margin may be, and/or may be referred to as, a Link Adaptation Margin, LAM.

The method further comprises at 820 selecting a transport format for the radio transmission based on the estimate of SINR for the radio transmission and the determined margin.

The transport format may be a transport block format. The transport format may be at least one of: a modulation and coding scheme; a precoder and a number of layers for the transmission. However, other examples of a transport format may occur to those skilled in the art.

The method may further comprise at 830 scheduling the radio transmission according to the selected transport format. This may comprise sending a scheduling assignment to a user equipment.

As mentioned above, the radio transmission may be an uplink transmission or a downlink transmission. In both cases, the network node may send a scheduling assignment to the user equipment for the radio transmission. This may inform the UE of the transmission time interval in which the UE should transmit or receive the transmission. For example, where the radio transmission is over PUSCH (Physical Uplink Shared Control Channel) the scheduling assignment may be transmitted, from the network node to the UE, in DCI (Downlink Control Information) over PDSCH (Physical Downlink Shared Channel). Further details are omitted, as details of such scheduling of transmissions will be readily understood by those skilled in the art.

The estimate of SINR for the radio transmission may be obtained in various ways. For example, the estimate may be based on measurements of reference signals transmitted over the uplink or downlink as appropriate, in which case the estimate may be determined directly or indirectly from these measurements.

For example, where the radio transmission is an uplink transmission, the network node may make measurements of reference signals transmitted over the uplink (from the UE to the network node) and estimate SINR from those measurements. These reference signals may be Sounding Reference Signal (SRS) or Demodulation Reference Signals (DMRS) or any other suitable type of signal which can be used to estimate SINR. On the other hand, where the radio transmission is a downlink transmission, the UE may make measurements of reference signals (transmitted from the network node to the UE) and transmit information based on those measurements to the network node which can be used by the network node to obtain or determine an estimate SINR. These reference signals may be Channel State Information Reference signals, CSI-RS, or any other type of reference signal transmitted over the downlink. This information may, for example, be transmitted to the network node in one or more CSI (Channel State Information) reports. Typically, a CSI report contains one or more of CQI (Channel Quality Indicator), RI (Rank Indicator) and PMI (Precoder Modulation Indicator). The network node may then estimate SINR based on the CSI report. Alternatively, the estimate of SINR may simply be received by the network node. For example, the UE could instead calculate estimated SINR, for example from measurements of reference signals, and transmit that estimate to the network, for example as a new parameter in a CSI report.

It is also possible that the estimate of SINR may be calculated (alternatively or in addition) based for example on HARQ feedback of previous transmissions, and/or a prediction of channel conditions in the next transmission interval. In one example, a machine learning/artificial intelligence algorithm may be implemented in the network node to predict/estimate SINR for the next (or a future) transmission. That is, a lot of data (for example but not exclusively on the reference signal measurements and HARQ feedback of previous transmissions) is collected and a machine learning algorithm may be applied to the data to predict or estimate the SINR which will be experienced by the next (or a future) transmission.

As mentioned above, the Applicant has identified, through observations of SINR estimation error statistics, that, by determining a margin to be applied to the estimate of SINR for a transmission in dependence on the value of the estimate of SINR, a smaller margin may be applied in some cases, whereby a more efficient transport format may be selected for the transmission as appropriate, without decreasing the reliability of the transmission below the desired level. For example, a higher MCS (which uses fewer radio resources to transmit the same number of information bits) may be selected, which may increase spectral efficiency, decrease interference in the network (by decreasing transmission load on the channel) and decrease the latency of the transmission, particularly as the resultant transport block, TB, may not need to be segmented for transmission.

More particularly, the Applicant has identified that a smaller margin may be required for lower estimates of SINR than for higher estimates of SINR.

In examples, the margin may be determined in dependence on a magnitude of the estimate of SINR for the radio transmission.

Further, in some embodiments, the margin may be determined according to a rule (or relationship) such that a smaller margin is selected for a lower estimate of SINR than for a higher estimate of SINR.

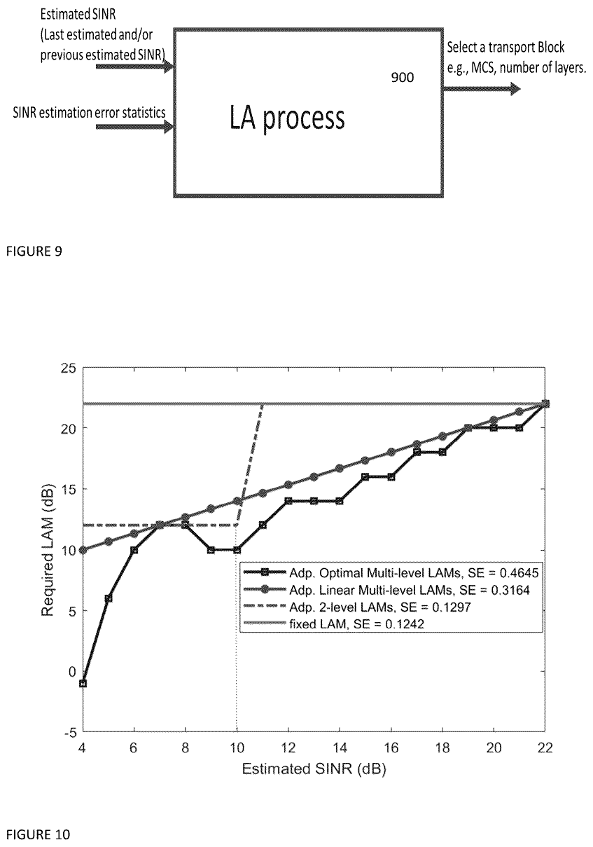

FIG. 9 is a schematic drawing of an LA process 900 according to an embodiment of the present invention. In this embodiment, estimated SINR (last estimated and/or previous estimated SINR) together with SINR estimation error statistics is input into the LA process or algorithm 900. These SINR estimation error statistics, in respect of previous transmissions, together with the estimate of SINR for the next transmission are used to select the transport format for that transmission.

More particularly, in this embodiment, the margin to be applied to an estimate of SINR may be determined in dependence on the value of the SINR estimate and based on calculations of SINR estimation error in respect of previous transmissions.

In embodiments, the margin is selected from a plurality of margin values. In this case, multiple (different) margins, rather than a single margin, may be calculated, for respective values of SINR estimation, for example based on the relevant SINR estimation error statistics from previous transmissions. That is, at least one of (and preferably at least two of) the margin values may be determined based on calculations of SINR estimation error in respect of previous radio transmissions. The method may then comprise selecting a margin for a transmission from the plurality of margin values in dependence on the value of the SINR estimate for the transmission.

It should be appreciated that each of the values of the plurality of margins, for the respective values of SINR estimate, may be determined so as, for example, to maximise the reliability of the system, to satisfy the required BLER whilst increasing spectral efficiency and/or reducing latency or such that the average BLER is lower than the required BLER in the system, yet spectral efficiency is improved.

FIG. 10 is a graph showing the required LAM for respective values of estimated SINR according to examples of the present invention. FIG. 10 shows three examples, referred to as: an “adaptive optimal multi-level LAM” method, an “adaptive linear multiple-level LAM” method and an “adaptive two-level LAM” method, as well as the prior art method where a fixed LAM is used for a transmission regardless of the value of SINR estimate.

In the adaptive optimal multi-level LAM method, in this example, a margin is determined for each integer value of estimated SINR in dB. In this example, the required LAM to achieve BLER=0.001 for different intervals of estimated SINR is considered and FIG. 10 shows an example based on the collected data from one experiment in a factory setting. The margin values for the adaptive optimal multi-level LAM method are plotted on the graph in FIG. 10 using squares. These margin values may be considered the “optimal” choice for each value of estimated SINR, at least if the SINR estimation error statistics are sufficient and reliable.

It can be seen from the graph that generally the higher the estimate of SINR, the higher the LAM required. This depends on the higher standard deviation of the SINR estimation error at higher estimated SINR. Using these margins, for the respective values of estimated SINR, the experiment showed that a spectral efficiency (in terms of resource elements (RE) per bit) of SE=0.4645 may be achieved. In comparison, the flat line indicates the control where a fixed one-level LAM is used as in the prior art for all values of estimated SINR for a transmission. Here a value for LAM at the top end of the plot for the adaptive optimal multi-level LAM is used, specifically in this example LAM=22 dB. The high value is necessary to ensure that a BLER of 0.001 is achieved at the highest observed estimated SINR in the experiment. In this experiment the spectral efficiency of the fixed LAM method was SE=0.1242. Thus, it is shown that use of the adaptive optimal multi-level LAM method can significantly increase spectral efficiency.

In the adaptive linear multi-level LAM method, a linear upper bound of LAM from the adaptive optimal method is used to determine the plurality of LAM values, for respective values of estimated SINR. These LAM values are plotted on the graph using circles.

In the adaptive two-level LAM approach, a first LAM value is used when the estimated SINR is below a threshold and a second LAM value (higher than the first LAM value) is used when the estimated SINR is above a threshold. In this example, a LAM value of 12 dB is used when the estimate for SINR is between 4 and 10, and a LAM value of 22 dB (the same as the fixed LAM) is used for higher values of estimated SINR.

The results show that both the adaptive two-level LAM approach and the adaptive linear multi-level LAM approach also improve spectral efficiency over the use of a fixed LAM for a transmission, although not as much as the adaptive optimal multi-level LAM method. In the experiment, the adaptive two-level LAM approach and the adaptive linear multi-level LAM approach had a spectral efficiency of SE=0.1297 and SE=0.3164 respectfully. However, the adaptive linear method produced better results than the adaptive two-level LAM result and results close to those of the optimal multi-level LAM method. Thus, the adaptive linear method may be a good candidate for implementation, as it may reduce complexity compared to the adaptive optimal multi-level LAM method but with limited negative impact on performance.

The adaptive linear multi-level LAM values may be estimated by collecting statistics of SINR estimation errors at a high estimated SINR and at a low estimated SINR and calculating the required LAM at these (end) points to achieve a desired reliability. The required LAMs at other estimated SINRs may then be calculated from these points through interpolation or extrapolation.

Thus, it will be understood that, where the margin is selected from a plurality of margins, at least two of the margin values may be for use with respective values of estimated SINR. In some cases, however, at least one of the plurality of margin values may be a value intrapolated or extrapolated from at least two other of the plurality of margin values. For example, this is the case in the “adaptive linear multi-level LAM” example described above. However, this approach may also be applied in the “adaptive optimal multi-level LAM” method in some cases, to determine LAM values for estimates of SINR intermediate the points where the “optimal” LAM has been calculated. It should be appreciated that, whilst in this example in the adaptive optimal multi-level LAM method an “optimal” LAM is calculated for each integer value of SINR, an “optimal” LAM value could be calculated for different intervals of estimate SINR.

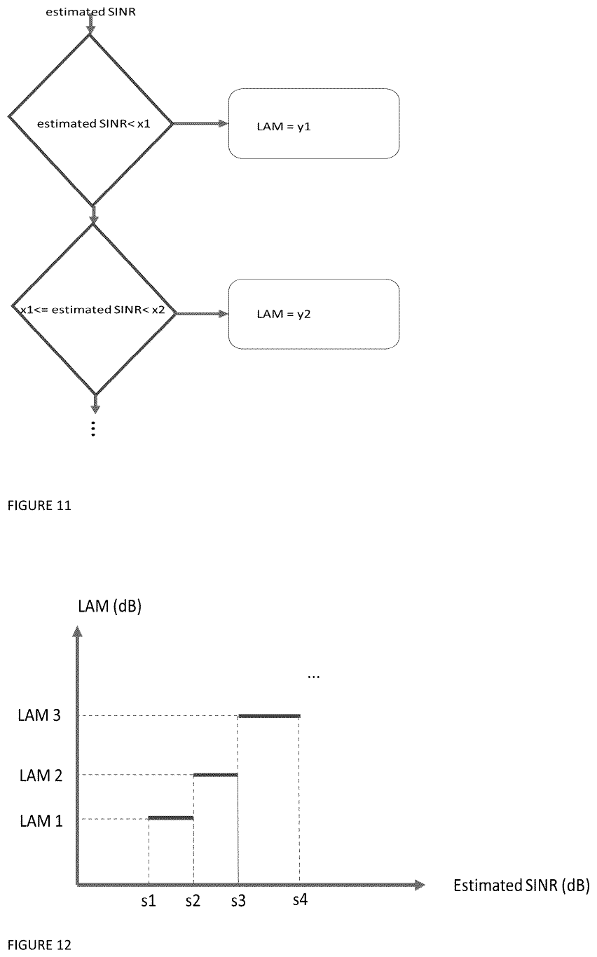

FIG. 11 is a flow diagram showing a method of selecting a LAM, according to an embodiment of the present invention.

In this embodiment, selecting the margin comprises selecting a first of at least two margin values when the estimate of SINR exceeds a threshold and selecting a second of at least two margin values when the estimate of SINR is lower than the threshold. In this case, the first margin is higher than the second margin.

In this example, if the estimated SINR is less than x1, LAM=y1 is selected, whereas if the estimated SINR is greater than x1 (but optionally lower than x2), LAM=y2 is selected. It should be appreciated that, whilst two possible LAM values are shown in FIG. 11, there may be one or more further LAM values, which for example may be selected where the estimated SINR exceeds x2.

FIG. 12 shows an example of a simplified version of the “adaptive multi-level LAM method” where the estimated SINR may be classified into different levels (s1 to s2, s2 to s3 and s3 to s4). Then, if the estimated SINR is between s1 and s2, LAM 1 applies; if the estimated SINR is between s2 and s3, then LAM 2 applies, and so on. It should be appreciated that there may be different numbers of possible LAMs/levels.

The LAM for the i^{th} interval (denoted as LAMᵢ) may be selected, for example, based on the following criteria: min LAMᵢ s. t. Expected Error probability <10⁻⁶ (BLER based on the required reliability). The “Expected Error probability” can be defined as the probability that SINR estimation error for the given Estimated SINR is less than zero. In this way, the smallest LAM which satisfies the reliability requirement can be selected.

Proper values of s1, s2, s3, . . . and the proper values for LAM1, LAM2, LAM3, . . . may be calculated or determined in various ways. For example, the method may comprise selecting “N” number of SINR points as s1, s2, . . . , SN and then considering them as fixed values. LAM 1, LAM2, . . . , LAM_{N} may then be determined for the respective levels such that the required reliability is achieved, for example as discussed above. LAM1, LAM2, . . . , LAM_{N} may also be determined such that the required reliability is achieved and spectral efficiency is maximized. Alternatively, the method may comprise jointly selecting “N” the number of SINR points, the values of s1, s2, . . . , SN and LAM 1, LAM2, . . . , LAM_{N} such that the required reliability is achieved and optionally such that spectral efficiency is maximized.

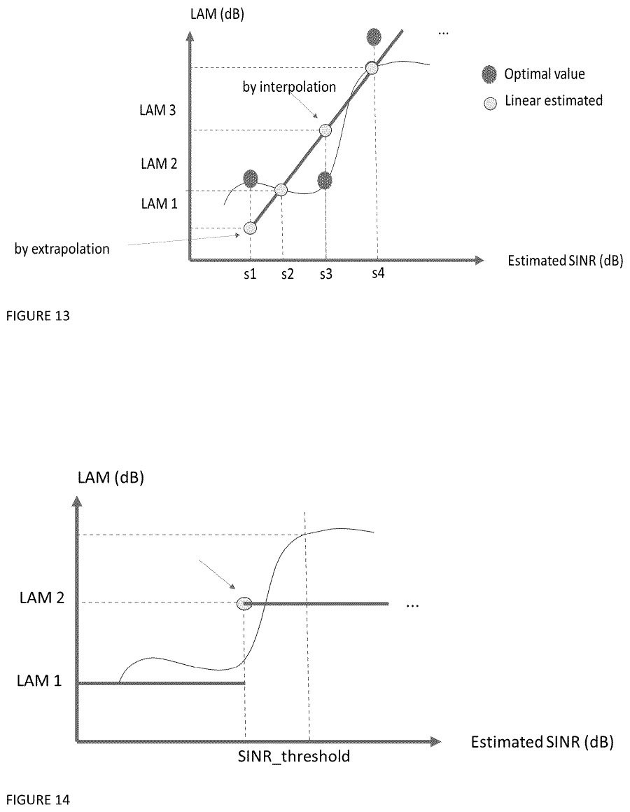

FIG. 13 is a graph showing LAMs for use with respective values of estimated SINR according to further examples of the present invention. More particularly, two examples are shown: a first, where the required or proper LAM is calculated for each of s1, s2, s3 and s4, and a second, where the required or proper LAM is only calculated for two values of estimated SINR (points s2 and s4). These margin values may be calculated, for example using collected measurements/data, as discussed above. In the second example, the LAMs for s1 and s3 are estimated using linear extrapolation/interpolation.

FIG. 14 illustrates a further example of LAM selection according to the “adaptive two-level LAMs” method. As mentioned above, selecting the margin for an SINR estimate may comprise selecting a first of at least two margin values when the estimate of SINR exceeds a threshold and selecting a second of the at least two margin values when the estimate of SINR is lower than the threshold.

The SINR threshold value may be determined based on measurements/input data, e.g. SINR estimation error statistics, desired reliability, etc. Then

```
if estimated SINR < SINR_threshold
  LAM 1
if estimated SINR >= SINR_threshold
  LAM 2
end
```

The values of LAM1 and LAM2 may be derived from measurements/input data as discussed above.

Generally, the multi-level margins may also be determined or calculated based on other factors, such as expected radio conditions and the requested service of the transmission, amongst others.

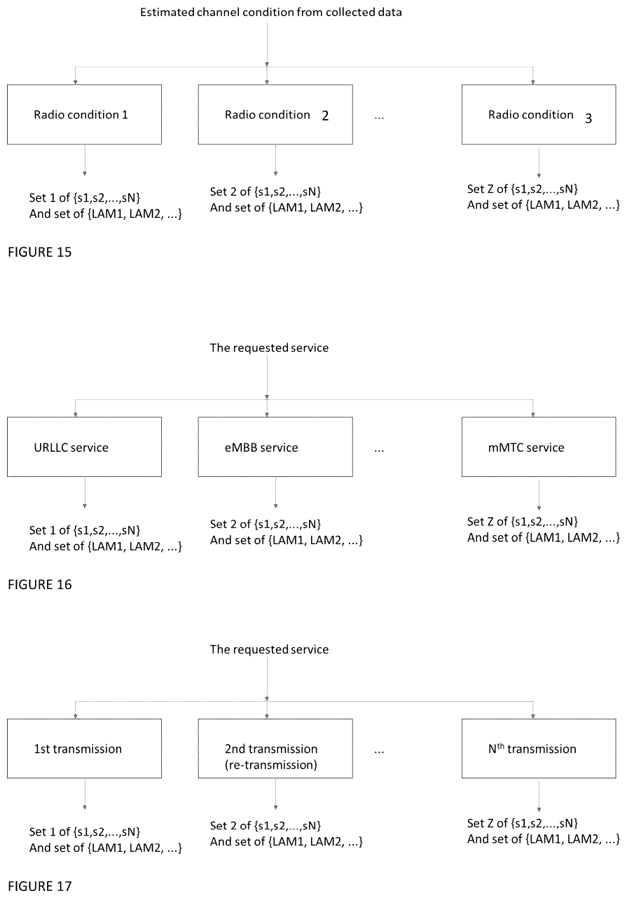

FIG. 15 illustrates a method of determining a margin to be applied to an estimate of SINR for a transmission according to an embodiment of the present invention. In this example, the margin, which is a LAM, may be determined (for example selected) in dependence on the value of the estimate of SINR for the transmission and based on environment or radio conditions.

As indicated in FIG. 15, prevailing or expected channel conditions may be estimated from collected data. In this example, there are multiple sets of s1, s2 . . . sN and LAM1, LAM2 . . . , which are applied depending on the radio conditions. If certain radio conditions exist (or are expected), referred to as “first radio conditions”, then the first set of s1, s2 . . . sN and LAM1, LAM2 . . . are used to select the LAM for a radio transmission, depending on the value of the estimate of expected SINR for the radio transmission as discussed above. If other radio conditions exist (or are expected), referred to as “second radio conditions”, then the second set of s1, s2 . . . sN and LAM1, LAM2, . . . are used to select the LAM for the radio transmission, depending on the value of the estimate of expected SINR and so on. For example, larger LAMs may be used on average if radio conditions are such that greater variation in SINR may be expected. The radio conditions may be for example varying amount of fading variations, where one radio condition has small fading variations while another radio condition has large fading variations. This may in turn depend on variations in mobility, i.e., how far or fast a UE or other objects in the environment moves. Other radio conditions that may vary can include interference. For example, one radio condition may be when there is little interference from neighboring cells while another radio condition has significant interference from neighboring cells.

FIG. 16 illustrates a further method of determining a margin to be applied to an estimate of SINR according to an embodiment. In this example, the margin, which is a LAM, may be determined (for example selected) in dependence on the value of the estimate of SINR for the transmission and based on a service type of traffic carried by the radio transmission. For example, whether the requested service is a URLLC service, an eMBB service or an mMTC service may be considered. In this example, FIG. 16 shows that a first set of s1, s2, . . . sN and LAM1, LAM2, . . . may be used to determine the LAM in dependence on the value of the SINR estimate for a transmission as discussed above, where the requested service carried by the radio transmission is a URLLC service. A second set of s1, s2, . . . sN and LAM1, LAM2, . . . , on the other hand, may be used to determine the LAM in dependence on the value of the SINR estimate for the transmission, where the requested service carried by the radio transmission is an eMBB service. A further, z, set of s1, s2, . . . sN and LAM1, LAM2, . . . may be used to determine the LAM as discussed, where the requested service carried by the radio transmission is an mMTC service.

FIG. 17 illustrates a further method of determining a margin to be applied to an estimate of SINR according to an embodiment of the present invention. In this embodiment, the margin, which is a LAM, may be determined (for example selected) in dependence on the value of the estimate of SINR and based on whether the radio transmission is a re-transmission. By way of example, FIG. 17 shows that a first set of s1, s2, . . . sN and LAM1, LAM2, . . . may be used to determine the LAM in dependence on the value of the estimate of SINR for the transmission, where it is the first time the requested service (or data) carried by the radio transmission is to be transmitted (i.e. the transmission is a first transmission). A second set of s1, s2, . . . sN and LAM1, LAM2, . . . are used to determine the LAM in dependence on the value of the estimate of SINR for the transmission, where the radio transmission is a re-transmission, meaning that this is the second time the radio transmission is to be transmitted (where for example the first time the transmission was not successfully received) and so on. The reason to have different sets of s1, s2, . . . , sN and LAM1, LAM2, . . . , for the first transmission and for a retransmission may for example be that the required bounded latency only allows a limited number of retransmissions and that increasing the margin for the retransmission increases the likelihood that the packet is correctly received within the latency requirement.

In some embodiments, the method of determining a LAM may further or alternatively comprise determining, for example selecting, a LAM in dependence on the value of the estimate of SINR and based on a service requirement, such as one or more of: a reliability requirement, a latency requirement, a spectral efficiency requirement and a BLER requirement.

For example, when a UE has two or more service types at the same time with different required reliability, the transport format (such as transport block size, MCS, number of layers) may be selected based on one of the following methods: To achieve the minimum required BLER (this guarantees the reliability for critical service type). Based on a weighted average of required BLERs of the different services. That is, if Service Type i has required BLERᵢ, then the target BLER will be based on w₁*BLER₁+w₂*BLER₂+ . . . +WN*BLER_{N for 0<=wi<=1} and w1+w2+ . . . +wN=1, and N=number of service types for a UE. To achieve the highest required BLER (this may provide the best spectral efficiency but with the cost of losing reliability for critical services).

In further embodiments, the method of determining a LAM may comprise determining, for example selecting, a LAM in dependence on the value of the estimate of SINR for the transmission and based on allocation size of the radio transmission.

In an example, the selected LAM may be specific to an allocation size. In this case, the estimated SINR statistics, which may be used to determine the LAM values, may be determined for the allocation size. For example, SINR from measurement/reporting may be wide-band measures yielding wide-band statistical measures such as mean and std (standard-deviation). However, if link adaption, LA, is to be performed for a non-wide-band allocation, the estimated SINR statistics measures such as mean and std may be determined by converting the wide-band statistics measures to non-wide-band statistics measures. This can be done by applying an assumption on the frequency-domain correlation of SINR. For example, if the wide-band consists of N sub-bands and the non-wideband allocation consists of n subband, then the non-wideband SINR std may be assumed to be

$$STD ( non - wide - band ) = \sqrt{\frac{N}{n}} STD ( wide - band ) ,$$

i.e. the SINR per subband are all assumed to be independent and identically distributed random variables. In other examples the SINR per subband may be assumed to be correlated which would yield a different, but straightforward from statistical theory, formula.

The method may also or alternatively comprise determining a margin in dependence on the value of the estimate of SINR for the transmission and an outcome of a previous transmission over the same communications channel.

In an embodiment, a multi-level LAM is selected based on estimated SINR, and the outcome of the previous transmission (e.g., HARQ feedback of the previous transmission). In this method OLLA (Outer Loop Link Adaptation) in the process of link adaptation is removed and all the processes of OLLA and ILLA are combined into one algorithm. However, in other examples, the OLLA and ILLA processes may remain separate. In this example, a LAM for a transmission may first be determined based on the value of the estimated SINR for the transmission, as described above, then the feedback from a previous transmission over the communications channel may be considered and an adjustment to the LAM made if required. For example, if the previous transmission was unsuccessful then

```
If HARQ feedback ==0 (i.e., unsuccessful transmission)
  LAM = LAM + compensation_level1
Otherwise (successful transmission)
  LAM= LAM + compensation_level2
end
```

Where

compensation_level2=(−k)*compensation_level1.

For K as a positive constant value. The values of compensation_level1 and compensation_level2, and K may be determined by the network node. For example, the network node may decide the LAM, compensation_level1 and compensation_level2, and K by a joint decision in relation to a set of parameters of Estimated SINR, and the outcome of the previous transmission (e.g., HARQ feedback in the previous transmission).

The above describes a method where a margin to be applied to an estimate of SINR for a transmission, when selecting a transport format for the transmission, is determined (or selected) by a network node. This network node selects the transport format for the transmission, and may be the same network node which schedules the transmission (according to the selected transport format). However, in some embodiments, the step of determining the margin for a SINR estimate may be performed by the user equipment.

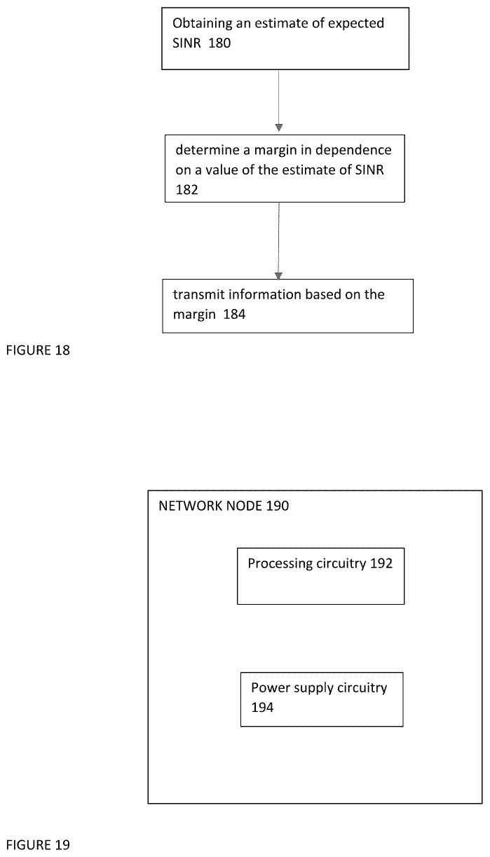

FIG. 18 is a flow chart showing a method, performed by a user equipment, for assisting selection of a transport format for a radio transmission according to an embodiment.

The method may comprise at 180 obtaining an estimate of expected Signal Interference to Noise Ratio, SINR, for a radio transmission. The method may further comprise, at 182, determining a margin in dependence on a value of the estimate of SINR. The method may further comprise at 184 transmitting information based on the margin to a network node to assist in the selection of a transport format for the radio transmission. This step may comprise transmitting the margin to the network node. The margin may be determined according to any of the examples described above.

According to an embodiment, the UE may receive a scheduling assignment from the network for the radio transmission (which transmission is scheduled according to the selected transport format, selected by the network node or the UE). The UE may then transmit the scheduled radio transmission or receive the scheduled radio transmission according to the scheduling assignment.

FIG. 19 is a diagram of a network node 190 according to an embodiment of the present invention. The network node comprises processing circuitry 192 configured to: obtain an estimate of expected Signal Interference to Noise Ratio, SINR, for a radio transmission; select a margin in dependence on a value of the estimate of SINR; and select a transport block format for the radio transmission based on the estimate of SINR for the radio transmission and the selected margin. The network node 190 further comprises power supply circuitry 194 configured to supply power to the processing circuitry 192.

The processing circuitry 192 may further be configured to perform any of the methods described above.

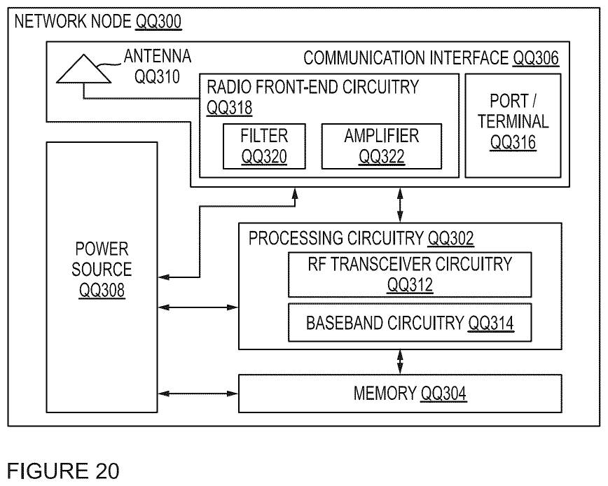

FIG. 20 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O & M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 19 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

The processing circuitry 182 is configured to: obtain an estimate of expected Signal Interference to Noise Ratio, SINR, for a radio transmission; select a margin in dependence on a value of the estimate of SINR; and select a transport block format for the radio transmission based on the estimate of SINR for the radio transmission and the selected margin.

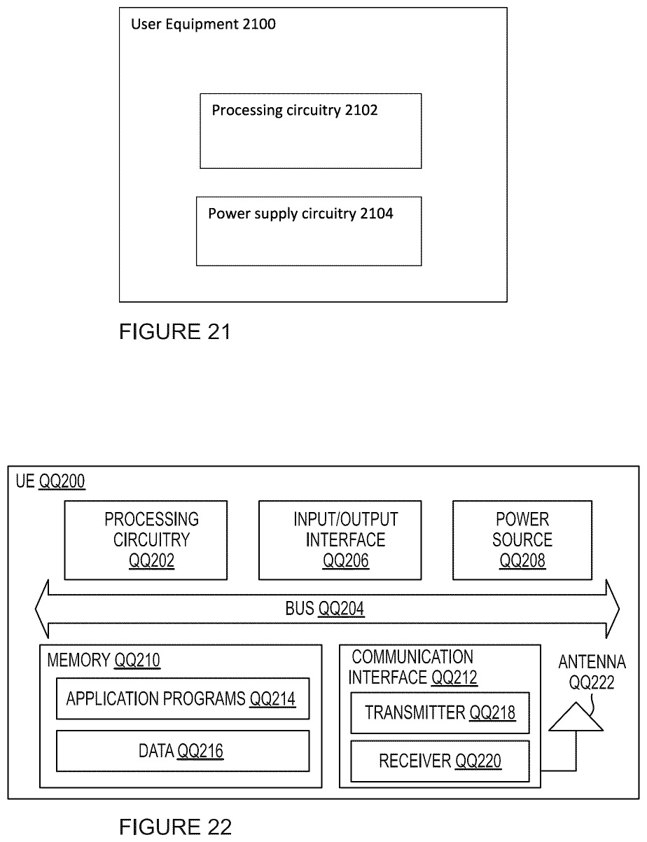

The processing circuitry 182 may further be configured to perform any of the methods described above. FIG. 21 shows a user equipment, UE, 2100 according to an embodiment of the present invention. The UE comprises processing circuitry 2102 configured to obtain an estimate of expected Signal Interference to Noise Ratio, SINR, for a radio transmission; determine a margin in dependence on a value of the estimate of SINR; and transmit information based on the margin to a network node to assist in the selection of a transport format for the radio transmission. The UE 2100 further comprises power supply circuitry 2104 configured to supply power to the processing circuitry 2102.

The processing circuitry 2102 may further be configured to perform any of the methods performed by a UE described above.

FIG. 22 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 22. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 21.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

The processing circuitry 202 is configured to obtain an estimate of expected Signal Interference to Noise Ratio, SINR, for a radio transmission; determine a margin in dependence on a value of the estimate of SINR; and transmit information based on the margin to a network node to assist in the selection of a transport format for the radio transmission.

The processing circuitry 202 may further be configured to perform any of the methods performed by a user equipment described above.

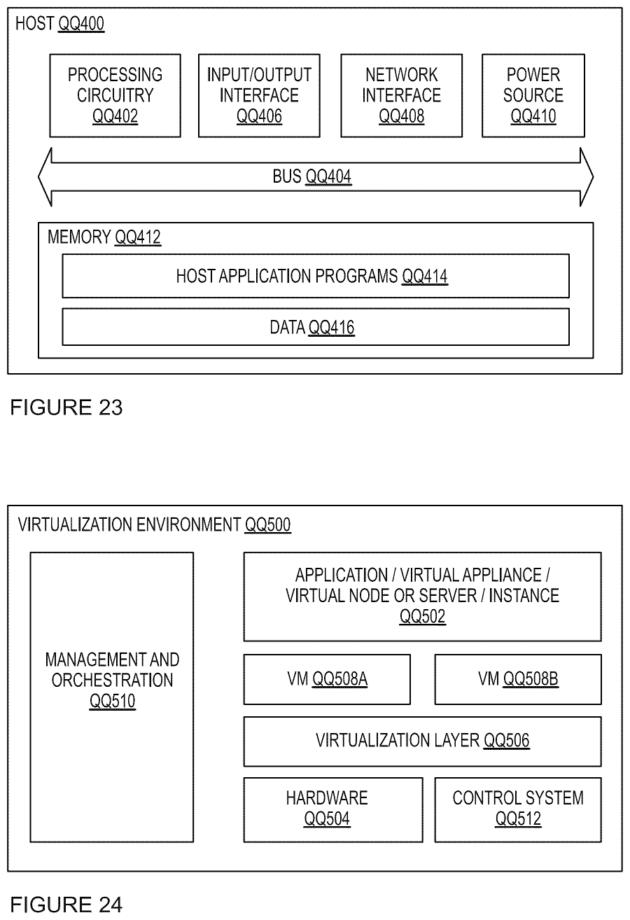

FIG. 23 is a block diagram of a host 400, which may be an embodiment of the host 116 of FIG. 5, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 20 and 22, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 24 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

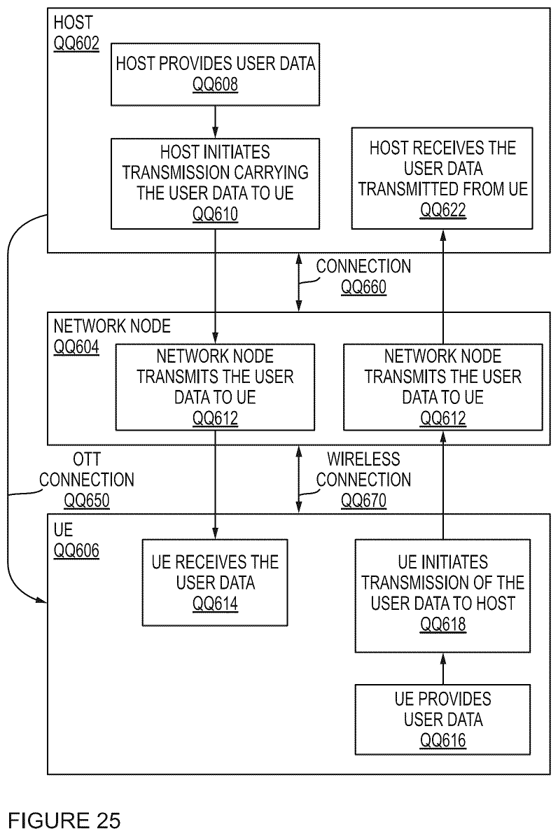

FIG. 25 shows a communication diagram of a host 602 communicating via a network node 604 with a UE 606 over a partially wireless connection in accordance with some embodiments. Example implementations, in accordance with various embodiments, of the UE (such as a UE 112a of FIG. 5 and/or UE 200 of FIG. 22), network node (such as network node 110a of FIG. 5 and/or network node 300 of FIG. 20), and host (such as host 116 of FIG. 5 and/or host 400 of FIG. 23) discussed in the preceding paragraphs will now be described with reference to FIG. 25.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 5) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602.

Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve the reliability, data rate and latency and thereby provide benefits such as reduced user waiting time, relaxed restriction on file size, improved content resolution and better responsiveness.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

According to an aspect there is provided a host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of the embodiments described above to receive the user data from the host. The cellular network may further include a network node configured to communicate with the UE to transmit the user data to the UE from the host.

The processing circuitry of the host may be configured to execute a host application, thereby providing the user data; and the host application may be configured to interact with a client application executing on the UE, the client application being associated with the host application.

There is also provided a method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the embodiments described above to receive the user data from the host.

The method may further comprise: at the host, executing a host application associated with a client application executing on the UE to receive the user data from the UE. The method may further comprise: at the host, transmitting input data to the client application executing on the UE, the input data being provided by executing the host application, wherein the user data is provided by the client application in response to the input data from the host application.

There is also provided a host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the embodiments described above to transmit the user data to the host.

The cellular network may further include a network node configured to communicate with the UE to transmit the user data from the UE to the host. The processing circuitry of the host is configured to execute a host application, thereby providing the user data; and the host application is configured to interact with a client application executing on the UE, the client application being associated with the host application.

A method implemented by a host configured to operate in a communication system that further includes a network node and a user equipment (UE), the method comprising: at the host, receiving user data transmitted to the host via the network node by the UE, wherein the UE performs any of the steps of any of the embodiments described above to transmit the user data to the host. The method may further comprise: at the host, executing a host application associated with a client application executing on the UE to receive the user data from the UE.

The method may further comprise: at the host, transmitting input data to the client application executing on the UE, the input data being provided by executing the host application, wherein the user data is provided by the client application in response to the input data from the host application.

There is also provided a host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations described above for example with respect of FIG. 8 to transmit the user data from the host to the UE.

The processing circuitry of the host may be configured to execute a host application that provides the user data; and the UE comprises processing circuitry configured to execute a client application associated with the host application to receive the transmission of user data from the host.

There is also provided a method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations described above for example with respect to FIG. 8 to transmit the user data from the host to the UE. The method may further comprise, at the network node, transmitting the user data provided by the host for the UE. The user data may be provided at the host by executing a host application that interacts with a client application executing on the UE, the client application being associated with the host application.

There is also provided a communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of described above for example with respect to FIG. 8 to transmit the user data from the host to the UE.

The communication system may further comprise: the network node; and/or the user equipment.

There is also provided a host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations described above for example with respect to FIG. 8 to receive the user data from a user equipment (UE) for the host.

The processing circuitry of the host is configured to execute a host application, thereby providing the user data; and the host application is configured to interact with a client application executing on the UE, the client application being associated with the host application. The initiating receipt of the user data may comprise requesting the user data.

There is also provided a method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps described above for example with respect to FIG. 8 to receive the user data from the UE for the host. The method may further comprise at the network node, transmitting the received user data to the host.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method, performed by a network node, for selecting a transport format for a radio transmission, the method comprising:
obtaining an estimate of expected Signal Interference to Noise Ratio, SINR, for the radio transmission;
determining a margin in dependence on a value of the estimate of SINR for the radio transmission; and
selecting a transport format for the radio transmission based on the estimate of SINR for the radio transmission and the margin.

2. A method according to claim 1, wherein the margin is a Link Adaptation Margin, LAM.

3. A method according to claim 1, wherein the margin is determined in dependence on a magnitude of the estimate of SINR for the radio transmission.

4. A method according to claim 3, wherein the margin is selected according to a rule such that a smaller margin is selected for a lower estimate of SINR than for a higher estimate of SINR.

5. A method according to claim 1, wherein the margin is selected from a plurality of margin values in dependence of the value of the estimate of SINR.

6. A method according to claim 5, wherein at least two of the margin values are for use with respective values of estimate SINR.

7. A method according to claim 6, wherein selecting the margin comprises selecting a first of the at least two margin values when the estimate of SINR exceeds a threshold and selecting a second of the at least two margin values when the estimate of SINR is lower than the threshold.

8. A method according to claim 6, wherein at least one of the margin values is a value intrapolated or extrapolated from at least two other of the plurality of margin values.

9. A method according to claim 1, wherein the margin is determined based on calculations of SINR estimation error in respect of previous transmissions.

10. A method according to claim 9 wherein the margin is selected from a plurality of margin values in dependence of the value of the estimate of SINR and wherein at least one of the plurality of margin values is determined based on calculations of SINR estimation error in respect of previous radio transmissions.

11. A method according to claim 1, wherein the margin is determined in dependence on the value of the estimate of SINR and based on at least one of:
a service type of traffic carried by the radio transmission;
a service requirement, such as one or more of: a reliability requirement, a latency requirement, a spectral efficiency requirement and a BLER requirement;
environment conditions;
allocation size of the radio transmission;
whether the radio transmission is a re-transmission; and
an outcome of a previous transmission over the same communications channel.

12. A method according to claim 1, wherein the radio transmission is an uplink radio transmission or a downlink radio transmission.

13. A method according to claim 1, wherein obtaining the estimate of SINR for the radio communication comprises at least one of:
estimating SINR based on reference signal measurements;
determining the estimate of SINR from one or more Channel State Information reports received from a user equipment;
receiving the estimate of SINR;
based on the outcome of one or more previous transmissions.

14. A method according to claim 1, wherein the transport format is a transport block format.

15. A method according to claim 1, wherein the transport format is at least one of a modulation and coding scheme; a precoder and a number of layers for the transmission.

16. A method according to claim 1, further comprising scheduling the radio transmission according to the selected transport format.

17. A network node comprising:
processing circuitry configured to:
obtain an estimate of expected Signal Interference to Noise Ratio, SINR, for a radio transmission;
determine a margin in dependence on a value of the estimate of SINR; and
select a transport format for the radio transmission based on the estimate of SINR for the radio transmission and the margin; and
power supply circuitry configured to supply power to the processing circuitry.

18. The network node according to claim 17, wherein the margin is a Link Adaptation Margin, LAM.

19. A method, performed by a user equipment, for assisting selection of a transport format for a radio transmission, the method comprising:
obtaining an estimate of expected Signal Interference to Noise Ratio, SINR, for a radio transmission;
determining a margin in dependence on a value of the estimate of SINR for the transmission; and
transmitting information based on the margin to a network node to assist in the selection of a transport format for the radio transmission.

20. A user equipment comprising: processing circuitry configured to:
obtain an estimate of expected Signal Interference to Noise Ratio, SINR, for a radio transmission;
determine a margin in dependence on a value of the estimate of SINR; and
transmit information based on the margin to a network node to assist in the selection of a transport format for the radio transmission; and
power supply circuitry configured to supply power to the processing circuitry.
